(19) United States
(12) Patent Application Publication
(10) Pub. No.: US 2025/0121440 A1
(43) Pub. Date: Apr. 17, 2025

(54) CUTTING AND DRILLING GUIDES FOR THE CONSTRUCTION OF WOOD STRUCTURES

(71) Applicant: James Kowalewski, Baltimore, MD (US)

(72) Inventor: James Kowalewski, Baltimore, MD (US)

(21) Appl. No.: 18/890,653

(22) Filed: Sep. 19, 2024

Related U.S. Application Data
(60) Provisional application No. 63/539,210, filed on Sep. 19, 2023.

(51) Int. Cl. B23B 47/28; B27B 27/08

(52) U.S. Cl. CPC B23B 47/287; B27B 27/08

(57) ABSTRACT

A cutting guides for posts are disclosed including an L-shaped guides that has an L shaped slop that is closed on opposite ends and which has hardened steel along the slot edges and in embodiments, the hardened steel is made from removable steel rods that are received in grooves that defines the sides of the L-shaped slop and further includes drilling guides for such posts that orient the location of a bore hole and are designed to maintain a cutting bit perpendicular to the work surface during a drilling operation.

### REFERENCE TO RELATED CASES

The Applicant claims the benefit of the filing date of U.S. Application No. 63/539,210 that was filed on Sep. 19, 2023.

### SUMMARY OF THE INVENTION

The present invention relates to cutting and drilling guides that may be used for wood construction including for decks, pergolas, pilings, fences, timber framing projects, carports and other structures that use wood support beams supported by posts.

### BRIEF DESCRIPTION OF THE DRAWINGS

FIG. 1 is a perspective view of a post in engagement with a beam with a pair of drill guide brackets attached to the front side.

FIG. 2A is a perspective view of the fixed portion of the mounting bracket according to the invention.

FIG. 2B is a perspective view of a sliding portion of the drill guide bracket according to the invention that receives a bushing,

FIG. 3 is a perspective view of a bushing that is received in a hole in the sliding portion of the drill bracket of FIG. 2B.

FIG. 4 is a top view of the bracket of FIGS. 2A and B in engagement with a post and lateral beam.

FIG. 5 is a front view in elevation of two brackets positioned on a post.

FIG. 6 is an enlarged side view in elevation of the bracket of FIGS. 2A and B in engagement with a post as marked by circle A in FIG. 7.

FIG. 7 is a side view in elevation of the two drill guide bracket assemblies of FIGS. 2 affixed to a upright post.

FIG. 8 is an exploded perspective view of an L shaped cutting guide used to provide top notches for posts.

FIG. 9 is an perspective view of the L shaped cutting guide of FIG. 8.

FIG. 10 is a top view of the cutting guide of FIG. 8.

FIG. 11 is a front view in elevation of the cutting guide of FIG. 8.

FIG. 12. is a side view in elevation of the cutting guide of Fig, 8.

FIG. 13 is a sectional view along line B-B of the cutting guide of FIG. 8.

FIG. 14 is perspective view of a pair of cutting guides positioned on the top of a post according to an embodiment of the invention.

FIG. 15 is a top view of a pair of cutting guides of FIG. 14 on a twisted post.

FIG. 16 is a top view of a pair of cutting guides of FIG. 14 positioned on a post.

FIG. 17 is a front view in elevation of a cutting guide positioned on a post.

FIG. 18 is a side view in elevation of two cutting guides positioned on a post.

FIG. 19 is a diagram for cutting two cutting guides from a single piece of steel.

FIG. 20 is a side view in elevation of a cutting guide according to that depicted in FIG. 14

FIG. 21 is an enlarged view of a portion of the cutting guide of FIG. 20.

FIG. 22 depicts the cutting guide of FIG. 14 used in connection with a different application.

FIG. 23 depicts a perspective view of an embodiment of a cutting guide that is attached to a post using quick release clamps.

FIG. 24 depicts an example of a quick clamp that can be used in connection with the invention wherein tubular sleeves (not shown) may be provided on the rod section.

### DETAILED DESCRIPTION

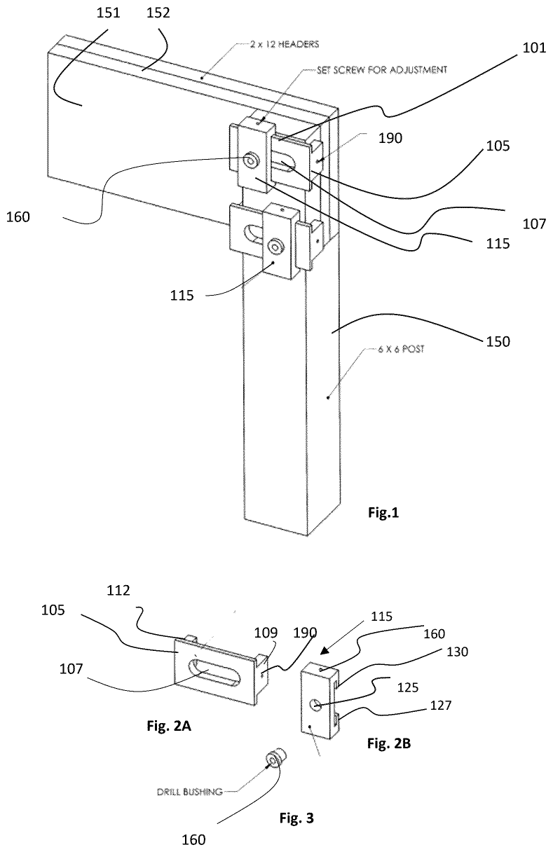

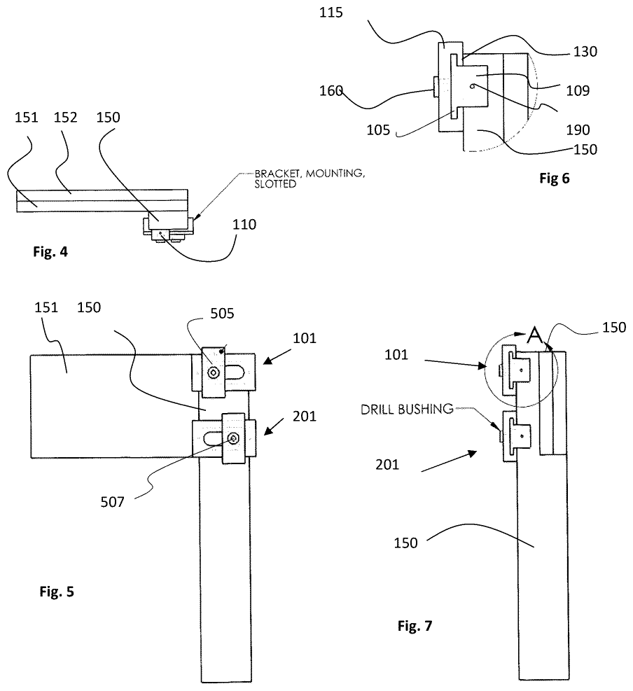

Now referring to FIGS. 1-7, the drill alignment brackets depicted provide for the positioning, securing, and adjusting a bushing that on a work surface such as a post or beam. Frequently, carpenters working in the field do not consistently drill holes that are perpendicular to work surfaces on posts, pilings or into headers or beams. These holes are typically created for the reception of carriage bolts or other fasteners. The drilling procedure is often performed on ladders or scaffolding and the drilling tool may have to be lifted overhead which may contribute to improper alignment. In some circumstances, the axis of the bore hole is incorrectly made at large angle from the desired orientation, which is typically 90 degrees. Misaligned holes in the resulting work piece may compromise the integrity of piece and reduce the strength of the material. Further, creating the hole at an undesired angle may break or crack the wood post or beam which may require fixing the post or complete replacement. If the hole is not at a correct angle, other holes through the post or beam may also be adversely affected. Further, if a hole misalignment happens after a post or piling has already been secured, such as in a foundation, the replacement may involve considerable additional time and expense.

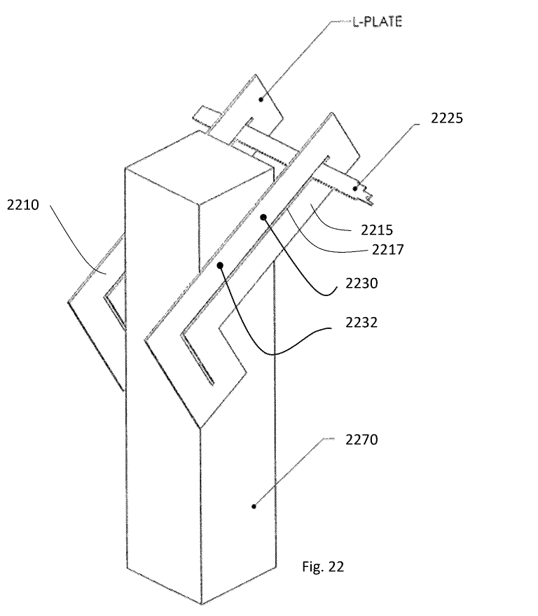

To address drill alignment problems, as depicted in FIG. 1 the present invention provides an drill alignment bracket assembly 101 that that allows for the location of a bore hole to be precisely sited and helps the carpenter or builder align a drill at a 90 degree angle with respect to the work surface or post 150. The drill alignment bracket includes a base element 105 and sliding clement 115 that receives bushing 160. As best seen in FIGS. 2A and 22 base element 105 has an elongated slot opening 107 that allows the user to laterally adjust the location of the bore hole with respect to the work surface. Side wing members 109 and 112 are oriented at an angle 90 degrees from the base and are attached to the post One or more mounting holes 190 are provided through a side wing member 109 that, as shown in FIG. 1, can receive a fastener to secure the bracket to the lateral side of post 150. Drill bracket 101 is shown attached to a post 150 that has been notched and which supports two headers or beams 151 and 152.

Referring back to FIGS. 2A and 2B, in embodiments, the drill alignment bracket assembly includes based bracket element 105 and sliding part 115 that also has a set screw hole 160 to allow it to be securely fastened to the top of base bracket 105. While base bracket 105 is depicted with two side wing sections 109 and 112 which are used to attach the base bracket to a post, in embodiments, only a single wing member is provided. Hole 190 though wing section 109 receives a screw that allow the base member 105 to be temporarily attached In embodiments that have a single wing member, the alignment bracket may be used on different sized posts, such as both 4×4 posts and 6×6 posts. The sliding portion 115 is attached to the base element by arm extensions 130 and 131 which allow sliding element to slide along the top surface of the base bracket and along the length of the slot. The sliding bracket part 115 can be secured in a designed position by a set screw that is entered into hole 160.

Referring to FIG. 3A, bushing 160 has a central opening that can receive a drill bit. Bushings with different sized central openings may be substituted to allow the user to select different sized drill bits that slide through the bushing and engage a work surface. In addition to bushings with different sized central opening, busing with different angles or alignments with respect to the beam surface may be provided, to allow, for example, a bore hole that is made at a 45 degree angle or other desired angles.

In further embodiments a base mounting bracket having a curved lateral dimension is provided which can fit around a portion of the circumference of a rounded post or pole. In this embodiment, the opposite ends of the base mounting bracket are provided with attachment devices, such as short nails that can temporarily be fixed to the post and then pried off when the drilling precure is completed. Alternatively, the bracket can attach using straps attached to the opposite ends of the bracket that can encircle the pole. The sliding bracket element for each embodiment remains substantially the same in each embodiment. In embodiments more than one sliding bracket may be attached to provide a stable base between the bracket and the work surface.

FIG. 5 depicts bracket assembly 101 having a first bushing 505 located on a first x and y location of post 150 and a second bracket assembly 102 with bushing 507 located at a different location on post 150. The use of the bracket assembly can facilitate alignment of the drill bit in circumstance when the length of the drill bit is not as long as the dimension of the post, beam or combination of post and beam, in which a though hole is desired and drilling is performed on opposite sides to create a continuous through hole.

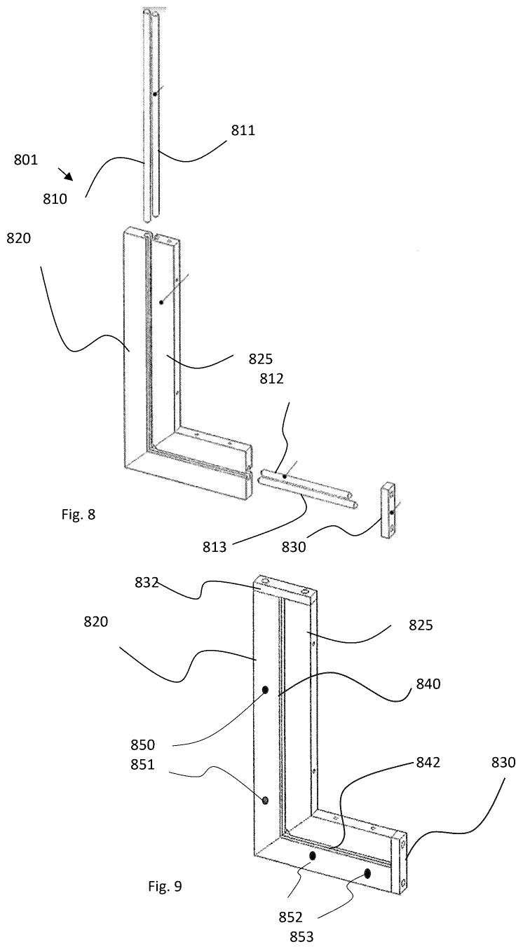

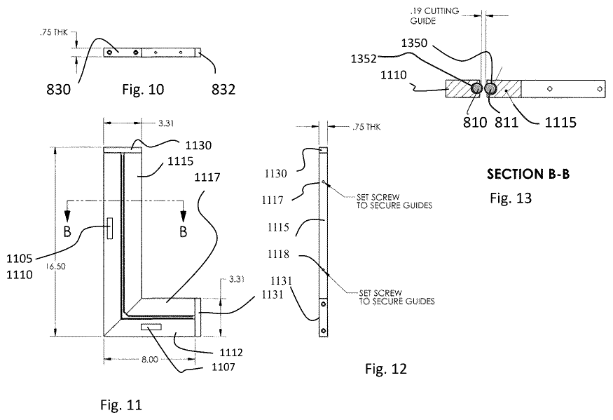

Now referring to FIGS. 8-15, an L-shaped cutting guide 801 that has an L-shaped slot opening. Cutting guide 801 is designed for cutting a notch in a post that is created to receive and support a header or beam. Referring now to FIG. 8, cutting guide 801 is comprised of two “L-shaped” anodized aluminum extruded parts 820 and 825 that enclose steel ⅜ diameter round rails 810, 811, 812 and 813. As best seen in FIG. 9, the bracket parts are retained together by end caps 830 and 832. Defining the lateral sides of vertical slot 840 are rods 810. 811, and horizontal slot 842 are rods 812 and 183. As seen in FIG. 13, the rods are received in channels 1352 and 1350 provided on a side surface of part 820 and 825. Similar channels are provided on the portion of the parts 820 and 825 that extend perpendicular to the upright portions. As seen in FIG. 9, the rods are secured in place by caps 830 and 832 as well as the channels in which they are received. FIG. 9 also depicts though holes 850, 851, 852 and 853 which are used to secure the guide to a work surface such as a post. In embodiments slots are provided to allow for adjustment of the guide on the work surface.

Now referring to FIG. 11, in embodiments, a leveling bubble gauges 1105 and 1107, as found in commercial levels, are provided in the vertical part 1110 and horizontal part 1112 of the cutting guide. In embodiments, each of the rails that are provided to define the slot have at least one end having a conical point that can form a ninety degree angle with a second rail where the guide turns 90 degrees.

Referring now to FIG. 13, a sectional view of rail 810 and 811 shows the rails received in complementary channels 1352 and 1350 and provided in parts 1110 and 1115 of the cutting guide. The use of hardened steel rails, in contrast with creating the entire guide from hardened steel, and providing an assembly or structure that allows the rails to be removed, reversed, and replaced when damaged or worn, can lower the costs of the device and increase its useful life.

Providing conical ends on the rails allows the inside corner of the “L-shape” to have two rail guides come to a 90 degree angle. In addition, if both ends have conical points, the guide rails can be flipped upside down and create a new wear pattern. As seen in FIG. 12, in embodiments set screws 117 and 118 are provided to prevent rotation of the rail guides in the channel. In other embodiments, the rail guides are allowed to rotate in the channels on the conical point received by the end caps thereby increasing the wearability of the guides.

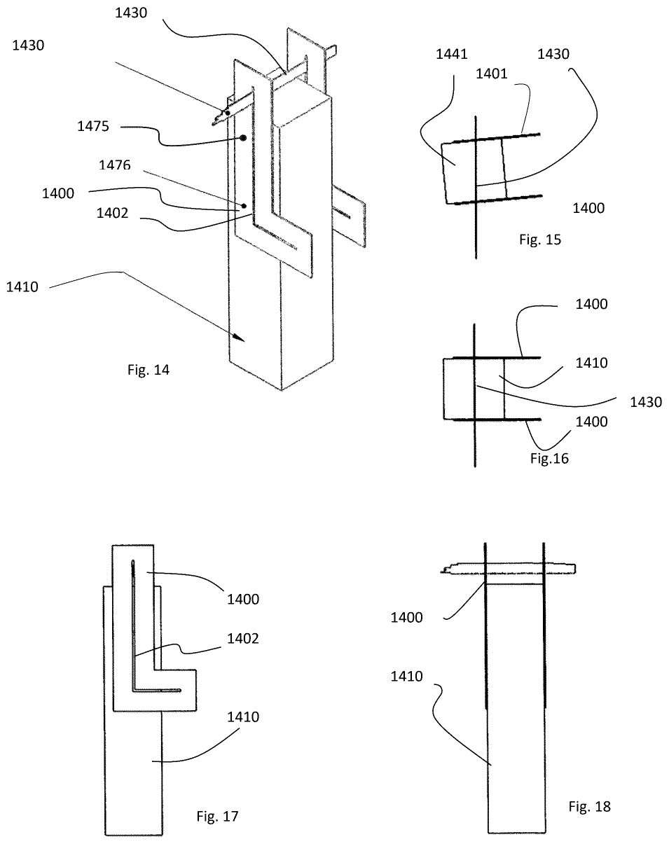

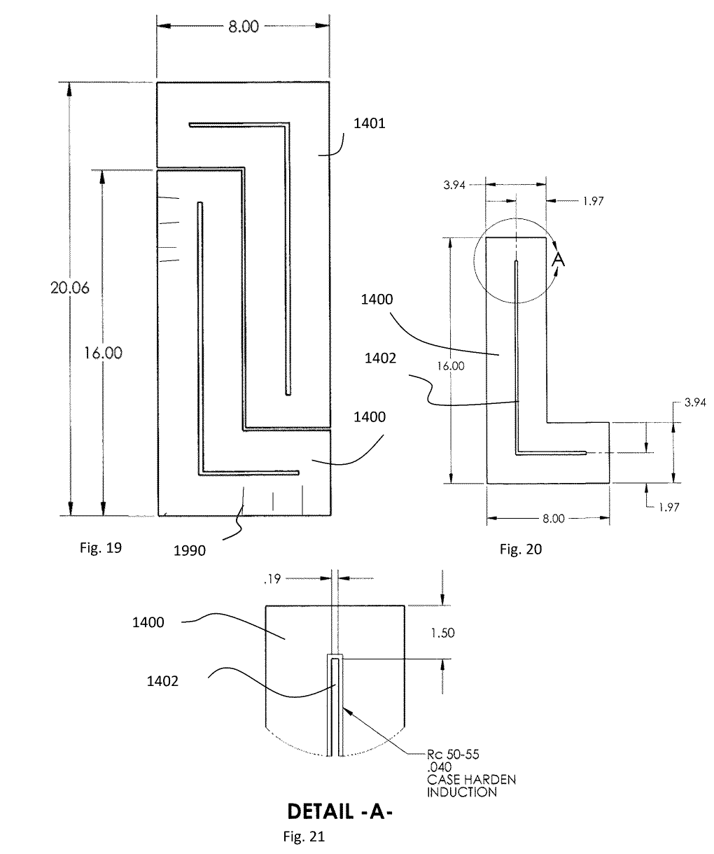

FIGS. 14-22 depict a further embodiment of a L-shaped cutting guides 1400 and 1401. These guides are made from a single piece of steel. The entire part or just the area of the guide that borders the cutting slot 1402 may be comprised of hardened steel to reduce wear. As best seen in FIG. 14, when attached to a post 1410, a reciprocating saw blade 1430 is inserted in the slot which maintains the blade in a vertical and straight alignment until it reaches the shorter horizontal section of guide 1400. The blade is then removed from the slot guide and inserted in the lateral slot to begin a second cutting operation is initiated from the lateral side of the post. The cutting process proceeds until the lateral or horizontal cut reaches the vertical cut. FIG. 19 depicts the relative dimensions of an embodiment of the invention and FIGS. 20 and also shows an example of proving measurement indicia 1990 on the guide's surface. FIG. 21 depict the location of an enlarged view of slot 1402 having a width of 19 inches.

Referring now to FIGS. 15 and 16, the guide assembly can be used on both conventional straight posts and posts that have twisted. In an embodiment, the brackets are attached to the posts with temporary fasteners that are removed when the cutting procedure is completed. As seen in FIG. 16 in an application, two complementary L shaped guides 1400 and 1401 are attached on opposite sides of the post and the slot is aligned at equal distances from the lateral surface of the post. a minimum distance apart by one or more tubular sleeves that receive the rods the does and provide a spacer between the opposite guides. In embodiments, the end of the rods, a quick clamp arrangement is as illustrated in FIGS. 22 wherein the pivoting the lever pulls the rod and compresses the opposite flanges together and secures the bracket against the post.

FIGS. 19-21 depict how two guides may be cut from a single piece of steel and FIG. 22 shows a further application of the guides used to create support members member for stairs and includes post 2270 with a guide 2210 fastened to a first lateral side and guide 2215 attached to a second lateral side. Guide 2215 guide is attached to post 2270 with fasteners 2230 and 2232 which pass through holes on the guide. A saw blade 2225 is shown within slot 217.

The embodiment of FIGS. 14-22 uses steel plates with induction hardened surfaces. There are two L-shaped assemblies on either side of the post. The bracket and slot are used for guiding a reciprocating blade and controls the geometry of the finished cuts. Using a reciprocating saw without a guide for this application is difficult and frequently results in uneven surfaces and both incorrect and inconsistent angles. In embodiments 4 gauge steel (0.1196 thick), is used. The guides are screwed to the post and are used in conjunction with typical speed squares and levels to accurately position the guide on the post.

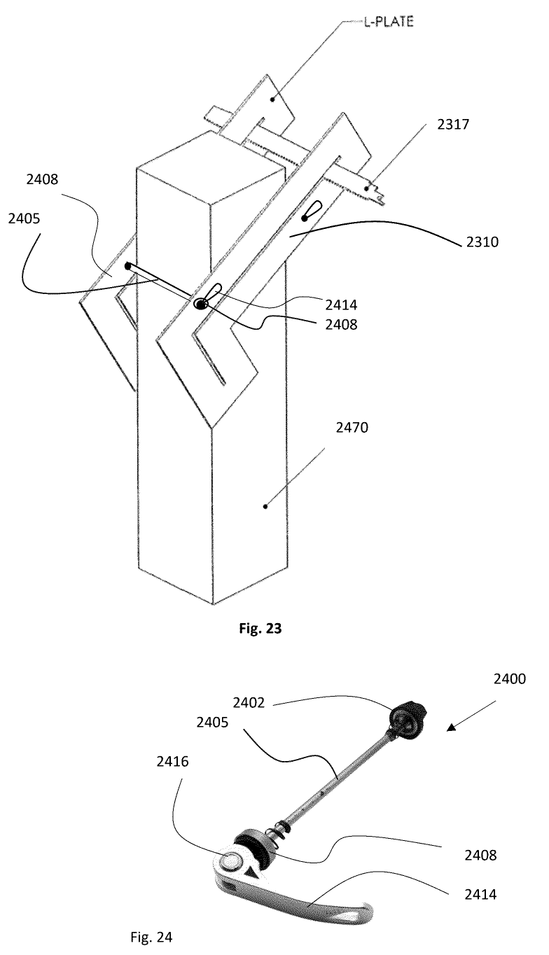

Referring now to FIG. 23, in embodiments, clamps are used to position two guide in place. A rod 2405 extends from a bolt or flange at one end, through a slot aperture in guide 2408 and then a second slot aperture in guide 2310 where a second flange 2498 is provided along with an adjustment lever 2414. AS best seen in FIG. 23, the flange on a first end 2402 of rod 2405 may be removed to allow insertion through the slots apertures. Flange 2408 on the opposite end of rod 2416 is provided along who lever 2412 to compress the two flanges together. In other contemplated applications, quick release clamps or conventional clamps, such as C clamps are used to temporality hold the guides in place.

All descriptions, embodiments, illustrations, depictions, drawings, features, and features made herein are for the purpose of revealing the invention and are not intended to limit the scope and application of the invention which is defined in the appended claims. The above-described embodiments are intended to be illustrative in all respects, rather than restrictive, of the embodiments. Thus, the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items. Therefore, it is to be understood that the present disclosure is not to be limited to the specific examples presented and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims.

I claim:

1. A cutting guide that designed to be attached to post comprising, an L shaped part, said part substantially flat on both sides, and a slot, said slot having a first section extending from a location near the top end of a first portion of said L shaped guide part and then extending in a direction 90 degrees and in the same direction as a second section of said the guide part to a position near an end of said second section, wherein said slot is completely enclosed by the sides and ends of said guide.

2. The cutting guide as recited in claim 1 further comprising through holes in said guide that are sized to receive fastener elements to allow said guide to be temporality attached to a work surface.

3. The cutting guide as recited in claim 1 wherein the material adjacent to said slot is comprised of hardened steel.

4. The cutting guide of claim wherein said guide comprise a first L shaped member a smaller second L shaped member a first end cap and a second end cap, wherein said slot is defied by the lateral right side of a first upright section of said first L shaped member, the top surface of a lateral section of said first L shaped member, a cap that engages the said lateral section of and lateral section of said second L shaped member, the bottom surface a said lateral section of said second L shaped member, a left side of said upright portion of said second L shaped member and a cap surface that connect the top of the first and second L shaped members.

5. The cutting guide as recited in claim 4 wherein sides walls and top, bottom and said side walls of said first and said second L shaped members that define said slot further comprise circular channels with an opening facing said slot, and said circular channels receive elongate circular rods along their respective length, and said rods substantially define said upper slot and lateral slot.

6. The cutting guide as recited in claim 5 wherein said rods have a 45 degree conical end and said conical ends of the rods that define the upper slot are in contact with the conical ends of the rods that define said lowers slot.

7. The cutting guide as recited in claim 1 further comprising a second guide and at least one clamp, wherein said clamp is removably attached to first and second guide and configured to draw said first guide toward said second guide.

8. The cutting guide as recited in claim 1 further comprising an integral bubble level.

9. The cutting guide as recited in claim 1 further comprising a measurement indicia to allow a user to oriented said guide to conform with determined cutting position of a work surface.
